(19) United States
(12) Patent Application Publication
(10) Pub. No.: US 2003/0020402 A1
(43) Pub. Date: Jan. 30, 2003

(54) Lamp electrode and assembly method

(76) Inventor: Ludwig P. Kiermaier, Edison, NJ (US)

Correspondence Address: Thomas L. Adams, 120 Eagle Rock Avenue, P.O. Box 340, East Hanover, NJ, 07936, US

(21) Appl. No.: 09/917,367

(22) Filed: Jul. 30, 2001

(51) Int. Cl. H01J 9/00; H01J 17/26

(52) U.S. Cl. 313/546; 313/490

(57) ABSTRACT

A lamp can be built with a collection that includes an electrode adapted to sustain bombardment from a stream of charged particles during an assembly process. The collection includes a metallic electrode shell attached to a supporting electrical lead. A tubular glass body encircling the shell has a rear tube extending away from the shell. The electrical lead is mounted in the glass body. A glass capsule is adapted to fit in the rear tube. The capsule has therein a conductive member that can be confined to the rear tube. The conductive member can be heated in order to open the glass capsule. The capsule contains a substance for delivering mercury upon opening of the capsule. The capsule is locatable in the rear tube at an offset distance from the metallic shell in order to avoid premature mercury delivery during bombardment of the metallic shell during the assembly process. One end of the rear tube can be sealed with the capsule loaded therein. After bombardment the capsule is heated to produce mercury that migrates toward the electrode. The rear tube may then be severed and sealed at a location adjacent the carrier to either excise the capsule or leave it in the rear tube close to the electrode.

### BACKGROUND OF THE INVENTION

1. Field of the Invention

The present invention relates to discharge lamps, and in particular, to apparatus and techniques for delivering a dose of mercury or like material into a sealed discharge chamber of a lamp.

2. Description of Related Art

Conventional gaseous discharge lamps as shown in FIG. 1 employ a metallic electrode in the form of a tubular shell 10 that is open at the distal end and closed at the proximal end. Shell 10 is often fitted at its open distal end with a non-conductive ceramic collar 12, but such a collar may be absent in some embodiments. The proximal end of shell 10 is supported at the hairpin turn of supporting electrical leads 11, whose two legs are embedded in a pinch seal 14 made in discharge tube 16, which is a tubular glass body. Tube 16 is typically fabricated in the field by fusing both ends of a long tube to a pair of short tubes that are provided by a manufacturer as part of an electrode assembly.

A rear tube 18, which is part of the electrode assembly, is fused at pinch seal 14 to communicate with the interior of discharge tube 16. The rear tube 18 is fused at location 19 to a loading tube 20 having a bulbous chamber 22 containing a drop of mercury 24. A technician assembling a lamp can fuse tube 20 to the end of end tube 18, insert mercury drop 24 with a syringe, and its rear will initially remain open to serve as an evacuation tube. Tube 20 is shown coupled to a process manifold 25, which can evacuate tube 17.

Discharge tube 16 is normally filled with an inert gas and mercury vapor. Before loading these fill gases, electrode shell 10 is bombarded with charged particles in the usual fashion in a partial vacuum. Thereafter, working with the process manifold 25 shown coupled to tube 20, a greater vacuum is pulled in tube 16 before loading an inert gas and tipping off the loading tube 20. Tube 16 is then tilted to load mercury drop 24 into tube 16, before tipping off rear tube 18 near the pinch seal 14.

A disadvantage with this procedure is the time required by a skilled technician. Also, the technician runs the risk of contacting the mercury, which is considered a hazardous material.

In U.S. Pat. No. 2,288,253 mercury is loaded in a lamp by opening a closed metal or glass container located in a discharge tube, with a high frequency heater coil. The glass containers have a metal element that can be heated in order to fracture the glass. A disadvantage with this design is the placement of the container next to the supporting glass stem so that the mercury container may be prematurely heated and opened during formation of, or heat sealing to, the stem. Consequently, the mercury vapor may be pumped out when the discharge tube is subsequently evacuated (in preparation for filling with an inert gas). This not only reduces the amount of mercury, but also can also foul the vacuum pump and present an environmental hazard.

U.S. Pat. No. 4,924,145 recognizes that a metal capsule containing mercury may be prematurely opened by the heat used to form a press seal around a glass stem in a fluorescent lamp. Instead of mounting the mercury capsule on a wire attached directly to the glass stem (FIG. 1), the capsule is mounted on a coil located in the center of the discharge tube (FIG. 4). However, that central location can prevent uniform illumination along the length of the device.

In U.S. Pat. No. 4,539,508 a metal container containing mercury or a mercury alloy is supported on a wire that is mounted in the glass stem of a discharge lamp to extend in front of an electrode filament. A discharge current in the lamp chamber flows through the container to release the mercury. Thereafter a temporary jumper between the support wire and the electrode filament is broken by a short current pulse. Again, the capsule is mounted on a support wire mounted directly on the glass stem.

In U.S. Pat. No. 4,553,067 a mercury containing target such as a disk of Ti₃Hg is mounted on an electrical lead between a glass stem and a filament electrode. This electrical lead is embedded in the glass stem and extends outside the lamp so that a high voltage can be applied between the target and the filament electrode. This high voltage bombards the target with charged particles to release the mercury. Again, this target is in a location where it can prematurely release mercury due to the heat produced during formation of the glass stem. In a similar design in U.S. Pat. No. 5,754,000 a mercury dispensing head is mounted on an electrical lead to allow bombardment of the head. Other arrangements include conductive heating of the head, movement of a mercury dispensing substance from an exhaust tube to a cup, a sealed container of mercury dispensing substance, etc. In all of these arrangements the mercury dispensing material is kept adjacent to either the electrode or a pinch seal. See also U.S. Pat. No. 3,297,898 showing an open cup located between an electrode and a press seal.

In U.S. Pat. No. 4,534,742 a wire attached to a filament lead in a fluorescent lamp supports a glass capsule at a location in front of the filament. Mercury inside the capsule is released by a pair of incandescent lamps that are focused on the capsule to melt an opening in it. A difficulty with this design is the inadequate support of the capsule by a wire loop encircling the capsule. The wire loop is attached to a lead embedded in the lamp base. Heat produced during processing or assembly of the base can heat and expand the wire loop so that the capsule will tend to slip out of the loop.

Other designs have mounted capsules in various ways, but have placed the mercury delivery device at or behind the electrode. Locations near a supporting glass stem will be vulnerable to the heat produced during formation or heat sealing of the stem. Locating the capsule close to the electrode exposes the capsule to the heat generated there, especially for non-filament electrodes (e.g., non-heated or cold cathodes such as in FIG. 1). The non-filament designs are normally bombarded during processing and assembly, which produces greater heat than that occurring with the processing conducted with filament electrodes in flourescent lamps. See also U.S. Pat. No. 5,256,935 (mercury alloy placed on cold cathode);

For the heated filaments of fluorescent lamps, mercury capsules have been mounted on or at a filament shield. For induction heating of a wire that lies across and cuts into a glass capsule mounted on a filament shield, see U.S. Pat. Nos. 3,764,842; 3,794,402; and 5,801,482. See also U.S. Pat. No. 5,394,056 (glass capsule mounted at filament is opened when external current is applied to heater-cutter wire). For a glass capsule mounted on a filament shield and containing a wire that is heated by RF induction to crack the glass, see U.S. Pat. Nos. 4,182,971 and 4,335,326. For a metal capsule on a filament shield that is opened by RF induction, see U.S. Pat. Nos. 4,056,750 and 4,282,455.

See also U.S. Pat. Nos. 2,283,189 and 2,322,421 (metal container of mercury opened by the heat of the filament electrode of a discharge lamp); as well as U.S. Pat. No. 2,415,895 (metal container behind an electrode and attached to one of its lead wires can be heated by a high frequency coil to crack open a glass ampoule containing mercury). For metal capsules containing mercury that are placed next to a filament electrode, see U.S. Pat. Nos. 4,754,193; 4,823,047; 4,870,323; and 5,278,473. For mercury containing capsules placed near the base of an indicator tube, see U.S. Pat. Nos. 2,991,387; 3,300,037; 3,684,345 and 3,895,709.

In U.S. Pat. No. 4,288,715 a dual chamber, metallic container can be mounted on the glass stem of a discharge lamp. One of these chambers is open and contains an amalgam, while the other chamber is initially closed but later opened by a high frequency field to release the mercury therein. See also U.S. Pat. No. 4,393,325 (amalgam in open metal capsule is placed between close fitting glass walls of discharge lamp).

In European Patent Specification 63,393 an amalgam in a metal container is attached to the filament lead of a discharge lamp. The container is located next to a glass stem so that amalgam spills onto the stem when the container is drilled opened with a laser beam. See also U.S. Pat. No. 3,898,511 (amalgam on back of heat shield located behind filament electrode).

In U.S. Pat. No. 3,657,589 a mercury-releasing getter device employs intermetallic compounds of mercury. The compound is loaded into a groove in an annulus and embedded on a shield surrounding the electrode filament of a fluorescent lamp. The compound can later be heated by a high frequency induction heater. In still other embodiments the compound is formed into a pellet around a heater wire for direct heating. This reference does not disclose techniques for appropriate mounting and positioning of the compound to avoid premature delivery of mercury caused by heat generated during lamp processing and assembly. For other applications of this compound, see U.S. Pat. Nos. 3,728,004 and 4,308,650.

In U.S. Pat. No. 3,983,439 a metal plate having a “FIG. 8” shape supports a metal cup containing mercury. The plate is snapped into place at an indentation in the exhaust tube of a fluorescent lamp. After the lamp is processed the plate and its cup are heated to release the mercury. See also U.S. Pat. No. 4,907,998. A difficulty with placing metal containers in an exhaust tube is that they are usually in close proximity to the exhaust tube. Consequently, they must be made fragile enough to rupture when subjected to heat without melting the exhaust tube. This renders a metal container more prone to leakage due to handling. In U.S. Pat. No. 3,913,999 (U.K. Patent Specification 1,419,098) a metal tube is formed by cold weld nipping, but this flares the ends of the tube. This requires the relatively large exhaust tube 18 shown in FIG. 2 and still places metal components in close proximity to the glass exhaust tube.

In U.S. Pat. Nos. 5,917,276 and 6,048,241 a glass capsule containing mercury is placed in a tube projecting from the discharge vessel of a mercury discharge lamp. A laser is used to swell the glass capsule and hold it in place before another laser beam melts an opening in the capsule. The timing of the heating cycle and the composition of the glasses must be carefully controlled to avoid puncturing the exhaust tube.

In U.S. Pat. No. 2,280,618 an amalgam is placed within a discharge tube at a distance from the electrodes. The amalgam is located in or at a side tube or inside a hollow perforated glass sphere. The amalgam maintains the partial pressure of mercury or other vapor at a desirable equilibrium value. The amalgam is not delivered by opening a closed container located inside the discharge tube, See also, U.S. Pat. No. 5,294,867.

In U.S. Pat. No. 3,957,328 an unencapsulated amalgam located in the exhaust tube of a discharge lamp is heated to release mercury vapors. Thereafter, the exhaust tube is tipped off near the lamp base to separate the amalgam, which is thereby sealed in a glass capsule that can be discarded. One difficulty is the need to keep the amalgam cool during lamp processing, and for this purpose, a cooling gas stream must be blown around the section of the tube containing the amalgam.

In U.S. Pat. No. 4,145,634 pellets of amalgam are freely distributed along the length of a fluorescent lamp tube and can be used as a means for delivering an initial dose of mercury during assembly. These arrangements adversely affect the package outline (side tubes) or block the light output from the discharge tube (coils or pellets located along the length of the discharge tube).

Amalgams have been placed in the tubular tip off region of solenoidal electric field (SEF) lamps. These lamps do not employ electrodes that are processed by bombardment and therefore have different design issues. The amalgam should be kept at a designated position in order to maintain a proper operating temperature. An amalgam must also be kept away from a melting tip during tipping off. For example, a springy tail or tight fitting cylindrical screen maintains the amalgam location in U.S. Pat. Nos. 4,499,400 and 4,528,209. In U.S. Pat. No. 5,629,584 glass balls and dimples (or tilting to slide an amalgam) maintain proper spacing of an amalgam in an exhaust tube of an SEF lamp. See also U.S. Pat. Nos. 5,751,110 (amalgam placed in open glass container located in exhaust tube of SEF lamp); 5,739,633 (glass rods maintain amalgam spacing in intermediate tip off region of fluorescent lamp); 5,994,837 (tube opening into discharge chamber of electrodeless, high frequency discharge lamp contains an amalgam and an amalgam-coated wire extending from the tube). In any event, these designs do not incorporate a container that opens after being sealed into a discharge tube in order to deliver a dose of mercury vapor in a lamp. Instead, these designs are concerned with regulating the partial pressure of the mercury vapor during normal lamp operation.

In U.S. Pat. Nos. 3,898,720; 4,020,378; 4,105,910; and 4,698,549 an amalgam is placed on the glass stem supporting the electrode in a fluorescent lamp, but amalgams so positioned will tend to be overheated if fused to the main discharge tube during lamp assembly. See also U.S. Pat. No. 5,841,220 (amalgam is placed on a wire supporting a lamp electrode at a location adjacent the electrode or at a location between the electrode and the glass supporting stem); and 5,814,936 (amalgam placed in open metal container attached to supply lead of filament electrode (or to glass core in a high frequency, electrodeless lamp)).

See also U.S. Pat. Nos. 4,691,141; 4,767,965; 5,022,882; 5,057,743; and 5,200,233.

### SUMMARY OF THE INVENTION

In accordance with the illustrative embodiments demonstrating features and advantages of the present invention, there is provided a collection for building a lamp with an electrode adapted to sustain bombardment from a stream of charged particles during an assembly process. The collection includes a supporting electrical lead and a metallic shell attached to the electrical lead. Also included is a tubular glass body encircling the shell and having a rear tube extending away from the shell. The electrical lead is mounted in the glass body. The collection also has a glass capsule adapted to fit in the rear tube. The capsule has embedded therein a conductive member sized to be confined to the rear tube and adapted to be heated in order to open the glass capsule. The capsule contains a substance for delivering mercury upon opening of said capsule. The capsule is locatable in the rear tube at an offset distance from the metallic shell in order to avoid mercury delivery from the capsule during bombardment of the metallic tube during the assembly process.

In accordance with another aspect of the invention, there is provided a lamp electrode adapted to sustain bombardment from a stream of charged particles during an assembly process. The lamp electrode includes a supporting electrical lead and a metallic shell attached to the electrical lead. Also included is a tubular glass body encircling the shell and having a rear tube with one closed end extending away from the shell. The rear tube communicates with the tubular glass body around the shell. The electrical lead is mounted in the glass body. The lamp electrode also includes a glass capsule loaded into the rear tube. The capsule has therein a conductive member confined to the rear tube and adapted to be heated in order to open the glass capsule. The capsule contains a substance for delivering mercury upon opening of the capsule. The capsule in the rear tube is spaced from the metallic shell an offset distance in order to avoid mercury delivery from the capsule during bombardment of the metallic tube during the assembly process.

According to another aspect of the invention, a method is provided for building a lamp with a metallic shell that is encircled by a glass body having a rearwardly extending tube. The method includes the step of loading into the rearwardly extending tube a carrier having a substance capable of delivering mercury upon heating of the carrier. Another step is sealing one end of the rearwardly extending tube. The method also includes the step of bombarding the electrode with a stream of charged particles while the carrier is kept at an offset distance in order to avoid mercury delivery from the carrier. Another step is heating the carrier to produce mercury that migrates toward the electrode. The method also includes the step of severing and sealing the rearwardly extending tube at a location adjacent the carrier.

By employing apparatus and methods of the foregoing type, improved techniques are achieved for delivering mercury to a discharge lamp. In a preferred embodiment a glass capsule containing mercury has a metal wire therein. This metal wire can be loose or can be embedded in an end of the glass capsule. Embedded wires can extend the full-length or only part of the length of the glass capsule. A selection of capsules may be provided so that an appropriate dose of mercury can be delivered in light of the lamp size. The capsule can be loaded into the exhaust tube of a discharge lamp before sealing the end of the tube. In some cases these capsules can be offered separately or can be factory installed in the exhaust tube as part of a “dud” electrode assembly.

Thereafter the lamp can be assembled and processed using most of the usual steps. Being properly located in the rear tube, the mercury capsule will be spaced from the electrode shell sufficiently so that during bombardment the capsule will not be heated and release its mercury. At an appropriate time a metal wire in the capsule can be heated by, for example, an induction heater to open the capsule and release the mercury. In some cases, the open capsule will be removed and discarded by tipping off the rear tube at a location between the electrode shell and the capsule. The capsule will then be hermetically sealed for safe disposal or recycling. In other embodiments, the rear tube will be tipped off to shorten the tube, but the capsule will remain in place close to the electrode to become part of the finished lamp.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a longitudinal sectional view of a discharge tube containing a tubular electrode shell with a rear tube fused to a loading tube containing a quantity of mercury, in accordance with the prior art;

FIG. 2 is a detailed, longitudinal sectional view of a glass capsule in accordance with principles of the present invention;

FIG. 3 in detailed, longitudinal sectional view of a glass capsule that is an alternate to that of FIG. 2;

FIG. 4 in detailed, longitudinal sectional view of a glass capsule that is an alternate to that of FIG. 2;

FIG. 5 in detailed, longitudinal sectional view of a glass capsule that is an alternate to that of FIG. 2; and

FIGS. 6A-6E illustrate a sequence of steps conducted with the mercury dispensing glass capsule of FIG. 2 fitted in a rear tube of a tubular glass body that contains a metallic electrode shell.

### DETAILED DESCRIPTION OF THE PREFERRED EMBODIMENTS

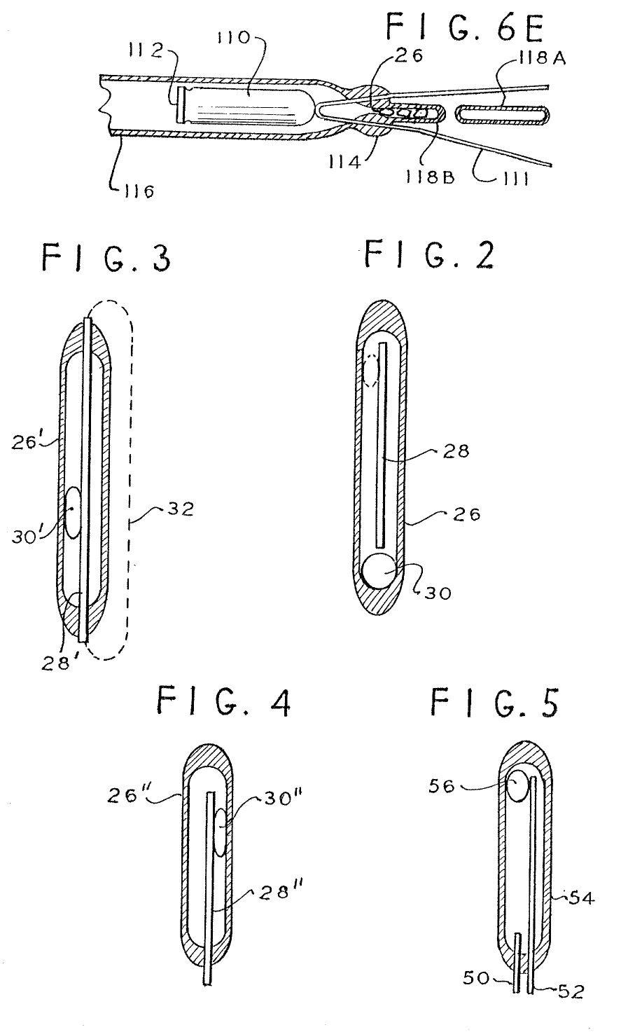

Referring to FIG. 2, a glass capsule 26 is formed from a short length of glass tubing. A conductive member such as wire 28 and a quantity of mercury 30 (herein referred to as a mercury dispensing substance) are placed inside the tubing. Thereafter each end of the tubing is tipped off to form the illustrated capsule with two sealed ends. In this embodiment conductive element 28 is loose within capsule 26. Capsule 26 and its contents are herein referred to as a carrier.

In the embodiment of FIG. 3 components corresponding to those previously illustrated in FIG. 2 have the same reference numeral marked with a prime. Here, conductive element 28′ runs the full length of glass capsule 26′. Consequently, the ends of element 28′ are sealed in the opposite ends of glass capsule 26′ to contain mercury 30′. In some embodiments, element 28′ may be in the form of a wire loop that closes on itself. This loop is suggested by dotted line 32.

Referring to the alternate glass capsule of FIG. 4, components corresponding to those previously shown in FIG. 2 have the same reference numeral but marked with a double prime. Glass container 26″ is closed at both ends and contains mercury 30″. Wire element 28″ is sealed at one end of container 26″ and extends into the inside of the container without extending its full length. Thus, the distal end of wire 28″ is free and the adjacent end of container 26″ does not have a wire embedded therein.

Referring to FIG. 5, a pair of side-by-side elements are in the form of wires 50 and 52. Glass capsule 54 is tubular and is sealed at one end, while the opposite end is sealed around wires 50 and 52. Wire 50 extends into the interior of glass container 54 a short distance, while wire 52 extends almost the full length of container 54 without being embedded in the distal end of the container. Constructed in this fashion, the device of FIG. 11 is essentially the same as a miniature mercury switch. In some embodiments a stock mercury switch may be employed for the purposes to be described presently.

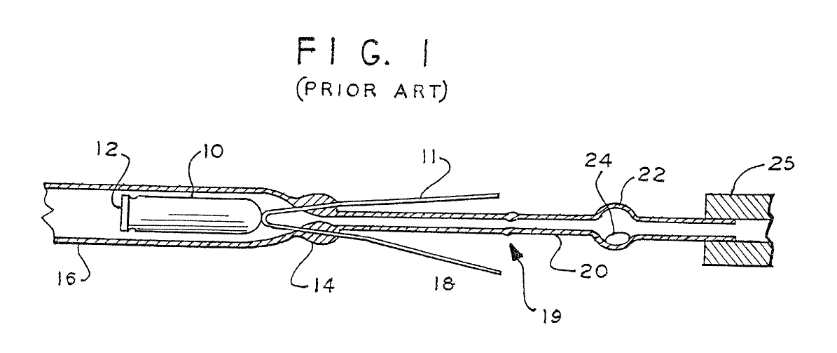

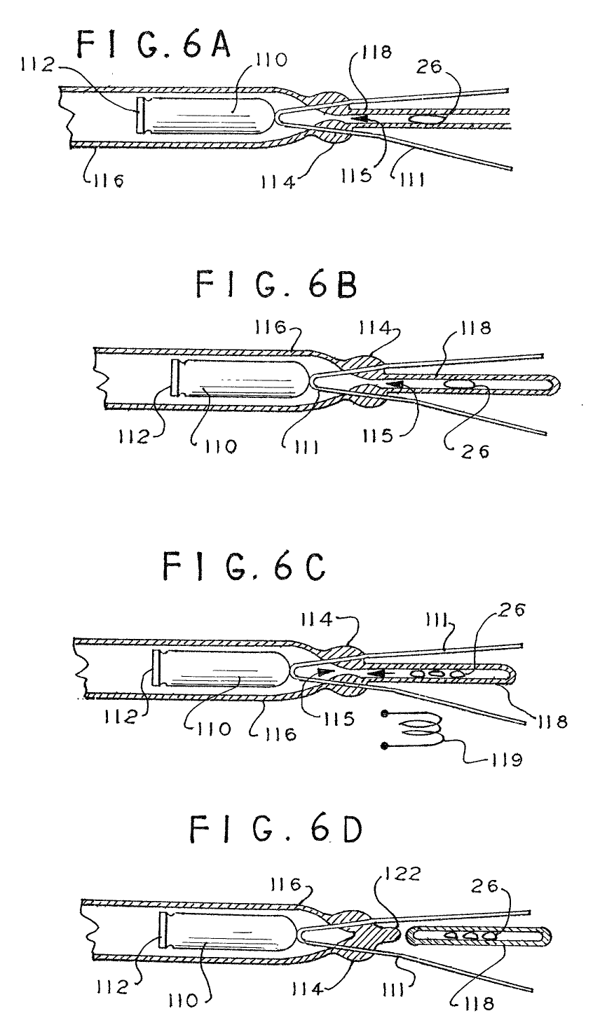

To facilitate an understanding of the principles associated with the foregoing apparatus, its operation will be briefly described in connection with the glass capsule 26 of FIG. 2 as portrayed in FIGS. 6A-6E. Capsule 26 is sized to fit in the rear tube 118 of FIG. 6A, which shows an arrangement similar to that of FIG. 1. Components in FIG. 6A corresponding to components in FIG. 1 bear the same reference numeral but increased by 100.

A technician will have available a variety of capsules similar to capsule 26. This variety of capsules will allow the technician to select a dose of mercury appropriate for the tube size. Since the selection of mercury doses are sealed in a glass capsules, the technician will not run the risk of contacting the mercury.

Shell 110 is normally provided from a manufacturer mounted inside a short glass tube 116 and supported on electrical leads 111 embedded in a pinch seal 114, but without the loading tube 20 shown in FIG. 1. Shell 110 is shown herein with a ceramic collar 112, but such a collar may be absent in other embodiments. A pair of these short glass tubes 116 are fused to either end of a longer discharge tube. The end illustrated in FIG. 6A is shown with glass capsule 26 fitted inside rear tube 118. The end of tube 118 will be tipped off as shown in FIG. 6B either at the factory or by a person assembling a lamp in the field. A narrowed orifice 115 within the pinch seal 114 will prevent capsule 26 from passing from the rear tube 118 into the discharge tube 116.

Installed at the opposite end of the discharge tube is a similar electrode mounted in a pinch seal and having a rear tube, except this rear tube will not be fitted with a glass capsule and will remain open for further processing. This open tube will be used to partially evacuate the discharge tube 116. Thereafter, a high voltage will be applied between the electrodes at the opposite ends of the discharge tube 116 to produce a bombarding stream of charged particles to heat the electrodes 110 and the discharge tube 116 in the usual fashion. As a result, any moisture in the lamp will be driven into a vapor state. In addition, an emission-enhancing coating on the inside of electrode 110, typically a mixture of metal carbonates or peroxides (or both), are converted to the corresponding oxides (sintering).

The flux of charged particles flowing during bombardment is concentrated primarily on electrode shell 110 since it has the greatest conducting surface. Also, the emission enhancing coating on the inside of shell 110 reduces the work involved in electron transfer so that current flow predominates on the inside 27 of the shell 26, especially as the carbonates and peroxides are converted to their corresponding oxides. In any event, electrode 110 will be heated usually to a point where it glows red.

The offset distance of capsule 26 may be adjusted to minimize any temperature rise therein. The offset distance is made great enough so that the radiant heat of electrode 110 does not substantially affect capsule 26.

After bombardment a greater vacuum will be pulled before loading an inert gas and tipping off the open rear exhaust tube to seal the discharge chamber 116.

An RF induction coil 119 (FIG. 6C) may now be brought near capsule 26 to generate an eddy current in wire 28 (FIG. 2). This heats mercury 30 to vaporize it and raise the pressure inside capsule 26, eventually rupturing the capsule as shown in FIG. 6C and allowing the mercury vapor to leak out. In some cases the glass capsule 26 can be opened by an intense radiation beam. For example, a laser beam can be used to melt a hole in glass capsule 26.

For embodiments employing capsule 26′ (FIG. 3), capsule 26″ (FIG. 4), or capsule 54 (FIG. 5) the foregoing procedures are essentially the same, except that the wires 28′, 28″, 50, and 52 are embedded in the respective glass capsules. Consequently, thermal expansion of these wires 28′, 28″, 50, and 52 will stress the capsules 26′, and 26″, and 54, causing cracking and further leakage.

For capsule 26′ (FIG. 3) wire 28′ may be formed into a loop as indicated by dotted lines 32. Therefore, an RF induction coil that produces magnetic flux perpendicular to the plane of this loop will provide a high degree of coupling, causing greater eddy currents to circulate in the loop.

In any event, mercury vapor released from capsule 26 will migrate through rear tube 118 through narrowed orifice 115 into the main chamber of discharge tube 116. The lamp can now be used as is, but in some embodiments tube 118 can be tipped off at a location between pinch seal 114 and capsule 26. As shown in FIG. 6D, tube 118 will be formed into a separate capsule hermetically containing capsule 26. A stub 122 is produced at the end of pinch seal 114 as a result of the tipping off.

Severing capsule 26/118 has the advantage of removing any fragments caused by the rupturing of capsule 26 so that no rattling sounds will occur when handling the lamp. Also, severed capsule 26/118 can be handled without exposing technicians to mercury.

In some instances capsule 26 will not be severed and disposed of as shown in FIG. 6D. Instead, the rear tube will be severed in two as shown in FIG. 6E to form an excised, tubular capsule 118A and a shortened tube 118B. Ruptured capsule 26 will remain in shortened tube 118B to become part of the finished lamp. Thus, the technician need not dispose of capsule 26. Shortened tube 118B is kept short enough so that it can be finished with a conductive cap, in the usual fashion.

It is appreciated that various modifications may be implemented with respect to the above described, preferred embodiment. For example, descriptions using the term mercury shall be deemed to include substances that have relevant properties similar to mercury in the context of a discharge lamp. For example, the term “glass” shall be considered broad enough to include materials that have glass-like properties. Also, while wires are shown inside a glass capsule, in some embodiments a metal element may be wrapped around the capsule. Furthermore, the wire may be replaced with a conductive element that is in the form of a strip or is shaped otherwise. In addition, the conductive element may be a conductive coating that is deposited on a surface of the capsule. In some embodiments the position of the capsule in the rear tube may be maintained by spacers placed in the tube adjacent to the capsule.

Obviously, many modifications and variations of the present invention are possible in light of the above teachings. It is therefore to be understood that within the scope of the appended claims, the invention may be practiced otherwise than as specifically described.

1. A collection for building a lamp with an electrode adapted to sustain bombardment from a stream of charged particles during an assembly process, comprising:
a supporting electrical lead;
a metallic shell attached to said electrical lead;
a tubular glass body encircling said shell and having a rear tube extending away from said shell, said electrical lead being mounted in said glass body; and
a glass capsule adapted to fit in said rear tube, said capsule having therein a conductive member sized to be confined within said rear tube and adapted to be heated in order to open said glass capsule, said capsule containing a substance for delivering mercury upon opening of said capsule, said capsule being locatable in said rear tube at an offset distance from said metallic shell in order to avoid mercury delivery from said capsule during bombardment of said metallic tube during the assembly process.

2. A collection according to claim 1 wherein said conductive member is loosely contained in said glass capsule.

3. A collection according to claim 1 wherein said rear tube has a narrowed orifice in communication with said metallic shell, said narrowed orifice being sized to prevent passage of said glass capsule through said orifice.

4. A lamp electrode according to claim 1 wherein said capsule has mercury inside.

5. A lamp electrode according to claim 1 wherein said capsule comprises an electrically conductive element embedded in and extending inside said container.

6. A lamp electrode according to claim 5 wherein said conductive element reaches across the length of the container.

7. A lamp electrode according to claim 5 wherein said conductive element comprises a wire.

8. A lamp electrode according to claim 5 wherein said conductive element comprises a side by side pair of elements.

9. A lamp electrode according to claim 5 wherein said conductive element comprises a loop passing through said container.

10. A lamp electrode adapted to sustain bombardment from a stream of charged particles during an assembly process, comprising:
a supporting electrical lead;
a metallic shell attached to said electrical lead;
a tubular glass body encircling said shell and having a rear tube with one closed end extending away from said shell, said rear tube communicating with said tubular glass body around said shell, said electrical lead being mounted in said glass body; and
a glass capsule loaded into said rear tube, said capsule having therein a conductive member confined to said rear tube and adapted to be heated in order to open said glass capsule, said capsule containing a substance for delivering mercury upon opening of said capsule, said capsule in said rear tube being spaced from said metallic shell an offset distance in order to avoid mercury delivery from said capsule during bombardment of said metallic tube during the assembly process.

11. A collection according to claim 10 wherein said rear tube has a narrowed orifice in communication with said metallic shell, said narrowed orifice being sized to prevent passage of said solid carrier through said orifice.

12. A lamp electrode according to claim 10 capsule has mercury inside.

13. A lamp electrode according to claim 10 wherein said electrically conductive element is embedded in and extends inside said container.

14. A lamp electrode according to claim 13 wherein said conductive element reaches across the length of the container.

15. A lamp electrode according to claim 13 wherein said conductive element comprises a wire.

16. A lamp electrode according to claim 13 wherein said conductive element comprises a side by side pair of elements.

17. A lamp electrode according to claim 13 wherein said conductive element comprises a loop passing through said container.

18. A lamp electrode according to claim 10 wherein said capsule comprises:
a porous metallic structure having liquid mercury or a mercury alloy retained therein.

19. A method for building a lamp with a metallic shell that is encircled by a glass body having a rearwardly extending tube, comprising the steps of:
loading into said rearwardly extending tube a carrier having a substance capable of delivering mercury upon heating of said carrier;
sealing one end of said rearwardly extending tube;
bombarding said electrode with a stream of charged particles while said carrier is kept at an offset distance in order to avoid mercury delivery from said carrier;
heating said carrier to produce mercury that migrates toward said electrode; and
severing and sealing said rearwardly extending tube at a location adjacent said carrier.

20. A method according to claim 19 wherein the carrier has a proximal and distal end, said proximal end being closer to said electrode than said distal end, the step of severing and sealing said rearwardly extending tube being performed at said distal end of said carrier in order to leave said carrier attached to said glass body and said metallic shell.

21. A method according to claim 19 wherein the step of severing and sealing said rearwardly extending tube is performed between said carrier and said electrode.

22. A method according to claim 19 wherein the step of heating said carrier is performed by directing radiation toward said carrier.

23. A method according to claim 19 comprising the step of: selecting said carrier with a capacity adequate for the size of the lamp.
